(19) United States
(12) Patent Application Publication
(10) Pub. No.: US 2011/0268339 A1
(43) Pub. Date: Nov. 3, 2011

(54) SYSTEMS AND METHODS FOR DETERMINING A LOCATION OF A LESION IN A BREAST

(76) Inventors: Lana Volokh, Haifa (IL); Ira Blevis, Zicron Yaakov (IL); Yaron Hefetz, Kibbutz Alonim (IL)

(21) Appl. No.: 12/771,987

(22) Filed: Apr. 30, 2010

(51) Int. Cl. G06K 9/00

(52) U.S. Cl. 382/132

(57) ABSTRACT

A system and method for determining an existence, uptake, size and location of a lesion within a breast is provided. The system includes a first detector and a second detector. The breast is positioned between the first detector and the second detector. The first detector acquires a first image data set of the lesion and the second detector acquires a second image data set of the lesion. The system also includes a existence, uptake, size and location determining program that uses the first image data set and the second image data set to calculate existence, uptake, size and location information for the lesion and determines a existence, uptake, size and location of the lesion within the breast based on the calculated existence, uptake, size and location information.

### BACKGROUND OF THE INVENTION

The subject matter disclosed herein relates generally to nuclear medicine (NM) imaging systems, and more particularly to methods and systems for estimation of tumor detection, uptake ratio, size and depth of a lesion imaged with the dual head (NM) system.

Mamography imaging is commonly used for the detection of breast cancer. Specifically, mamography imaging is used to detect lesions within the breast. Typically, the lesion is detected using three-dimensional imaging techniques. As such, a location and depth of the lesion can be determined from the image. The depth of the lesion aids, for example, in guiding a biopsy needle during extraction of a lesion sample for pathology.

However, some women cannot be effectively tested because of dense breasts and/or implants. Accordingly, these women may be tested using nuclear single photon imaging. Such imaging only provides two-dimensional images of the lesion having no depth information. When the depth of the lesion is unknown, guiding a biopsy needle is difficult and the chance of missing the lesion with the needle is high. As a result, a large number of samples may have to be taken, thereby causing pain and discomfort to the patient.

### BRIEF DESCRIPTION OF THE INVENTION

In one embodiment, a method of determining a location of a lesion within a breast imaged between a first detector and a second detector is provided. The method includes acquiring a first image data set of the lesion with the first detector and acquiring a second image data set of the lesion with the second detector. The method also includes using the first image data set and the second image data set to calculate location information for the lesion and determining a location of the lesion within the breast based on the calculated location information.

In another embodiment, a system for determining a location of a lesion within a breast is provided. The system includes a first detector and a second detector. The breast is positioned between the first detector and the second detector. The first detector acquires a first image data set of the lesion and the second detector acquires a second image data set of the lesion. The system also includes a location determining program that uses the first image data set and the second image data set to calculate location information for the lesion and determine a location of the lesion within the breast based on the calculated location information.

In yet another embodiment, a method of determining a location of a lesion within a breast is provided. The method includes acquiring image data of the lesion and calculating a plurality of location information for the lesion using the acquired image data. The method also includes weighting the plurality of location information to determine the location of the lesion within the breast.

### BRIEF DESCRIPTION OF THE DRAWINGS

FIG. 1 is a front view schematic of a system providing two-dimensional imaging of a breast.

FIG. 2 is a side view of the system of FIG. 1.

FIG. 3 is a schematic illustration of an exemplary nuclear medicine imaging system constructed in accordance with various embodiments of the invention.

FIG. 4 is a flowchart of a method for determining a location of a lesion in a breast in accordance with the various embodiments.

FIG. 5 is an illustration of a cross-section of the imaging subsystem of the camera shown in FIGS. 1-3

FIG. 6 is an illustration of the image data acquired by the detectors shown in FIGS. 1-3.

FIG. 7 is an illustration of images data shown in FIG. 5 and beam profiles of the image data.

FIG. 8 is a flowchart of another method for determining a location of a lesion in a breast in accordance with the various embodiments.

FIG. 9 is a flowchart of another method for determining a location of a lesion in a breast in accordance with the various embodiments.

FIG. 10 is a flowchart of another method for determining a location of a lesion in a breast in accordance with the various embodiments.

FIG. 11 is an illustration of a beam profile of the data acquired with the detectors shown in FIGS. 1-3, 5.

FIG. 12 illustrates the locus of possible source locations of the lesion shape.

FIG. 13 illustrates a single pixel acceptance and a single pixel source kernel.

FIG. 14 illustrates a build up of locus from the repeated addition of a kernel.

FIG. 15 illustrates a locus cone for each head constructed.

FIG. 16 illustrates an iteration scheme in accordance with an embodiment.

FIG. 17 illustrates the iterative scheme according to FIG. 15.

FIG. 18 illustrates the iterative scheme according to FIG. 15.

FIG. 19 illustrates the iterative scheme according to FIG. 15.

### DETAILED DESCRIPTION OF THE INVENTION

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Also as used herein, the phrase “reconstructing an image” is not intended to exclude embodiments in which data representing an image is generated, but a viewable image is not. Therefore, as used herein the term “image” broadly refers to both viewable images and data representing a viewable image. However, many embodiments generate, or are configured to generate, at least one viewable image.

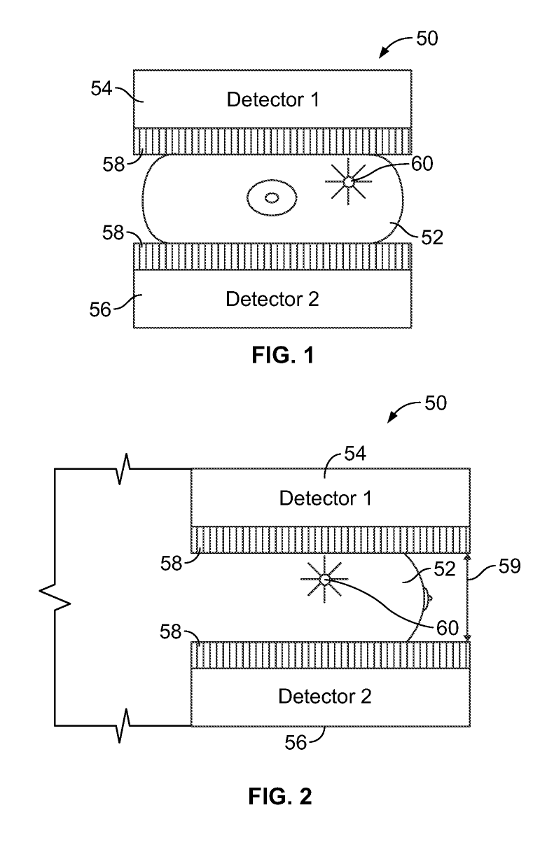

FIG. 1 is a front view of a system 50 constructed to provide two-dimensional imaging of a breast 52. FIG. 2 is a side view of the system 50 shown in FIG. 1. System 50 includes a first detector 54 and a second detector 56 illustrated as planar single photon imaging detectors. The first and second detectors 54 and 56 are illustrated in a parallel relation. The first and second detector 54 and 56 may be formed of cadmium zinc telluride (CZT) tiles or could be any two-dimensional pixilated detector. The detectors 54 and 56 may also include collimators provided directly on the surface of the detector illustrated as parallel hole collimators 58. According to the exemplary embodiment of the current invention, detectors 54 and 56 are capable of being rotated to some angle to provide various images of the breast 52 while remaining substantially parallel to each other. Additionally, distance between the two detectors may be changed to accommodate breasts with different sizes and to immobilize the breast for the duration of data acquisition by applying light pressure to it. The distance between near faces of the two collimators 58 is registered automatically or manually.

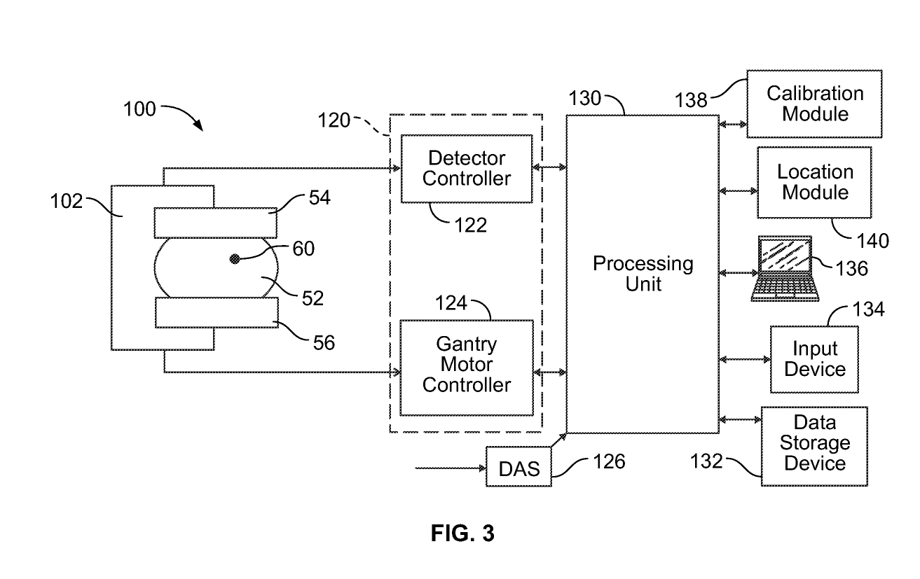

During operation, the breast 52 is positioned between the detectors 54 and 56 and at least one detector is translated to lightly compress and/or maintain the position of the breast 52 between the detectors 54 and 56. It should be noted that the compression of the breast 52, shown in FIGS. 1 and 2, is exaggerated for illustration. The detectors are then used to provide image data of breast 52 and one or more lesions 60, for example a breast cancer tumor, within the breast 52. As can be seen, lesion 60 may be located some depth within the breast, and thus at different distance from each detector, thereby creating different image data in each detector 54 and 56. As described in more detail below, the images from the detectors 54 and 56 are used to determine a position as well as depth of the lesion within the breast. As will be appreciated by one of skill in the art, the system 50 may be part of a system 100 as described in FIG. 3. Preferably, the distance 59 between the faces of the two collimators, which is equal to the thickness of the (slightly compressed breast) is registered by the camera and is available to a data analysis program.

FIG. 3 is a schematic illustration of an NM imaging system 100 including imaging detectors 54 and 56 mounted on a gantry 102. Each detector 54 and 56 captures a two-dimensional image that may be defined by the x and y location of a pixel and a detector number. Further, in other exemplary embodiments, at least one of the detectors 54 and 56 may change orientation relative to a stationary or movable gantry 102. The detectors 54 and 56 are registered so that features appearing at a given location in one detector can be correctly located and the data correlated in the other detector.

Each of the detectors 54 and 56 has a radiation detection face (not shown) that is directed towards a structure of interest, for example lesion 60, within the breast 52. Radiation detection faces are covered by a collimator 58, as described above. Although illustrated as a parallel hole collimator 58, different types of collimators as known in the art may be used, such as pinhole, fan-beam, cone-beam, and diverging type collimators. An actual field of view (FOV) of each of the detectors 54 and 56 may be directly proportional to the size and shape of the respective imaging detector, or may be changed using a collimator.

A motion controller unit 120 may control the movement and positioning of the gantry 102 and/or the detectors 54 and 56 with respect to each other to position the breast 52 within the FOVs of the imaging detectors 54 and 56 prior to acquiring an image of the breast 52. The controller unit 120 may have a detector controller 122 and gantry motor controller 124 that may be automatically commanded by a processing unit 130, manually controlled by an operator, or a combination thereof. The optionally gantry motor controller 124 and the detector controller 122 may move the detectors 54 and 56 with respect to the breast 52 individually, in segments or simultaneously in a fixed relationship to one another. Optionally, one or more collimators may be moved relative to the detectors 54 and 56. Preferably, a distance between detectors 54 and 56 is registered by controller 120 and is used by processing unit 130 during data processing. In some embodiments, motion is manually achieved and controller 120 is replaced with scales or preferably encoders for measuring at least the distance between detectors and, optionally, their orientation and/or the compression force exerted by at least one detector on the breast.

The detectors 54 and 56 and gantry 102 remain stationary after being initially positioned, and imaging data is acquired, as discussed below. The imaging data may be combined and reconstructed into a composite image comprising two-dimensional (2D) images and depth information.

A Data Acquisition System (DAS) 126 receives analog and/or digital electrical signal data produced by the detectors 54 and 56 and decodes the data for subsequent processing in processing unit 130. A data storage device 132 may be provided to store data from the DAS 126 or reconstructed image data. An input device 134 also may be provided to receive user inputs and a display 136 may be provided to display reconstructed images.

The NM imaging system 100 also includes a calibration processor 138 that uses acquired image data to calibrate either of the detectors 54 and 56. For example, at least one of energy calibration and sensitivity calibration may be performed, as well as bad pixel marking or interpolation on a pixel by pixel basis for the imaging detectors 54 and 56. Although FIG. 3 shows the calibration processor 138 as a module, it will be appreciated that the calibration processor 138 can also be a program, software, or the like stored on a computer readable medium to be read by the system 100.

In the exemplary embodiment, system 100 also includes a location module 140 configured to perform the methods described herein, for example, to determine the depth of a lesion in a breast. Although FIG. 3 shows the location module 140 as a module, it will be appreciated that the location module 140 can also be a program, software, or the like stored on a computer readable medium to be read by the system 100.

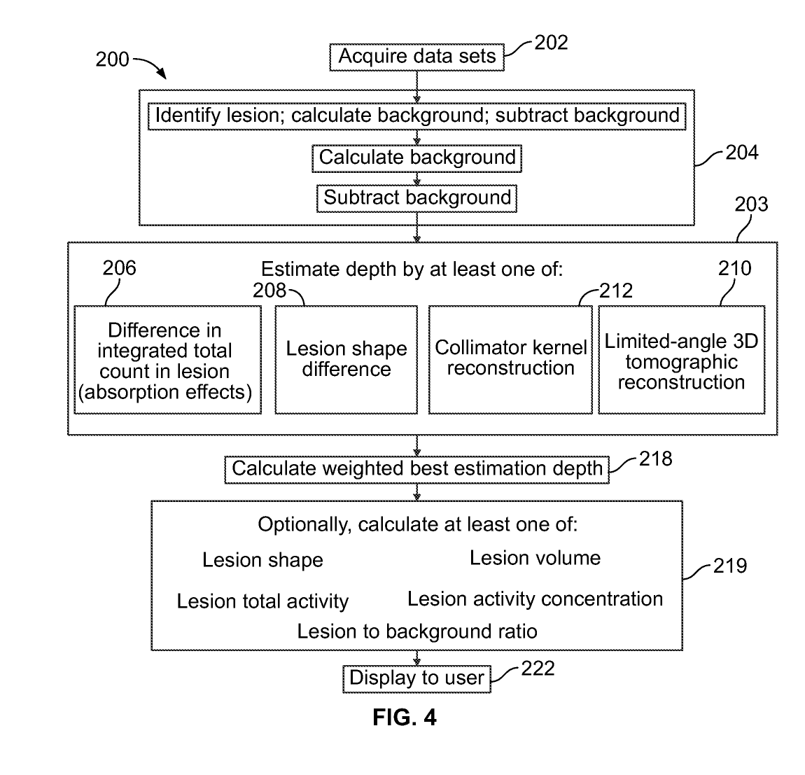

FIG. 4 illustrates a method 200 for determining a position or location of a lesion in a breast in accordance with the various embodiments. Method 200 only processes and/or manipulates the image data and does not modify the detectors, the collimators or the data acquisition method. In the exemplary embodiment, the method 200 is carried out by the location module 140. However, as noted above method 200 may be performed with a program, software, or the like stored on a computer readable medium. Specifically, at 202, image data is acquired from both detector 54 and detector 56. More particularly, a first image data set is acquired from detector 54 and a second image data set is acquired from detector 56. The image data sets in the various embodiments are two-dimensional data sets that include the number of events (i.e. photon counts) acquired within a given energy window, or the energy of each event detected by the detector.

At 204, a background is removed from each data set using the methods described below. In an analysis stage 203, the data set of the first detector 54 is then compared to the data set of the second detector 56 using at least one of the methods 206, 208, 210 and 212. Specifically, the method of 206 compares the total number of counts within a lesion boundaries of each data set acquired by detector 54 and 56 and performs attenuation based calculation to estimate the depth of the lesion. The method of 208 compares the profiles of the image of the lesion on each detector based on each data set acquired by detector 54 and 56. Depth estimation is done by comparing the width of the lesion profile and the known resolution with distance of the collimators. The method of 210 uses linear iteration of each data set acquired by detector 54 and 56 to estimate the shape and depth of the lesion. Method 212 uses collimator kernel reconstruction of the data set acquired by detector 54 and 56 to estimate the shape and depth of the lesion. Each of these methods will be described in more detail below.

After comparing the data sets, a position of the lesion 60 within breast 52 is determined from at least one of the methods 206, 208, 210, and 212. At 218, each of these positions is weighted to determine a weighted position of the lesion 60 in the breast. The weighting method of 218 is described in more detail below. Depth estimations are computed at 203 and analyzed to produce the best estimation of lesion depth, for example, by weighted averaging. In an optional post analysis step 219, the best estimation of depth is used for at least one of: correcting a shape of the lesion by correcting collimator spread due to depth; calculating a lesion volume based on the corrected shape of the lesion; calculating a corrected lesion activity based on the known attenuation and estimated depth; calculating a lesion activity concentration based on corrected lesion activity and lesion volume; and calculating a lesion uptake to background isotope concentration based on lesion activity concentration and background activity calculated in 204. At 222 the data is presented to a user.

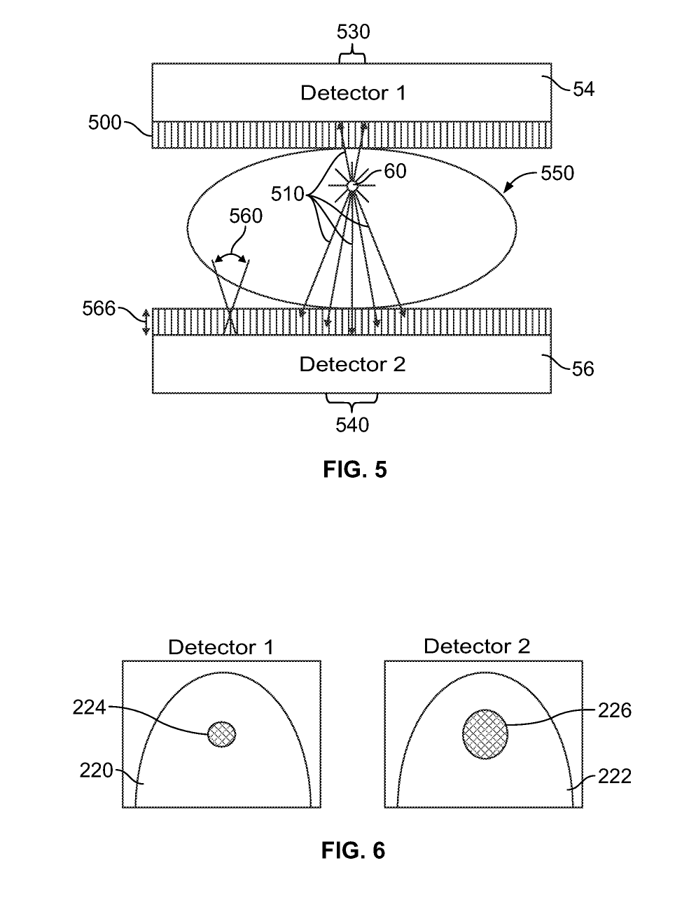

Referring to the data acquisition step at 202 of FIG. 4, FIG. 5 illustrates data collection by the detectors. A collimator septa 500 blocks some of the photons 510 emitted by the lesion 60. Specifically, any photon having an oblique angle larger than the acceptance angle 560 defined by the collimator bore diameter and collimator height 566 is blocked. An image footprint 540 of the lesion 60 is larger 540 on detector 54 than a footprint 530 on detector 56 as the lesion 60 is closer to detector 54 as indicated by the photons 510 that pass through the collimator's bores. A background isotope concentration 550 produces an almost even radiation pattern on the detectors.

FIG. 6 illustrates image data collected by each detector 54 and 56. The image 220 illustrates the data acquired by detector 54 and the image 222 illustrates the data acquired by detector 56. Because the lesion 60 is positioned closer to the detector 54, the lesion image 224 appears smaller and has a higher count than the lesion image 226 due to collimator depth related loss of resolution. Conversely, because the lesion 60 is positioned further from the detector 56, the lesion image 226 appears larger and has a lower count than the lesion image 224. It should be noted that this effect is more pronounced for high sensitivity collimators. However, a contrast ratio on the image is reduced when low resolution collimators are used. By comparing these images using at least one of methods 206, 208, and 210 an actual location of the lesion may be determined, as described in more detail below.

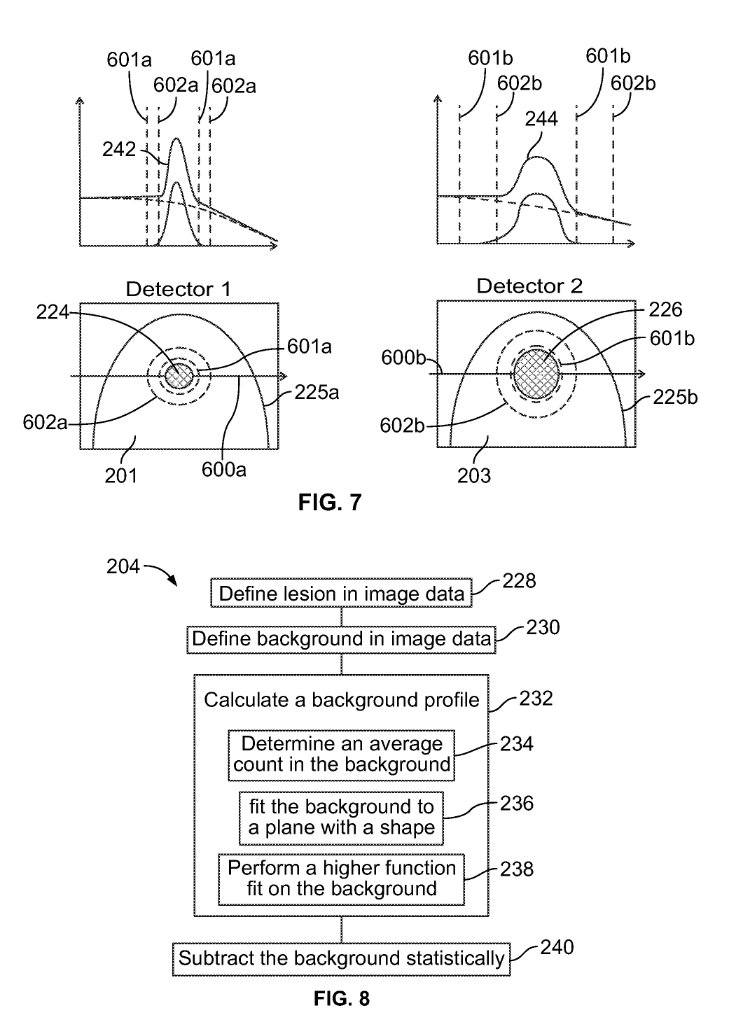

FIG. 7 schematically depicts the images 201 and 203 on the detectors 54 and 56. FIG. 8 illustrates a method 204 for subtracting a background of each image 201 and 203. An axis 600a and 600b may be extended through the center of the lesion 224 and 226. Each image 224 and 226 displays an image of the breast 225a and 225b, due to the background radiation of the normal tissue. An image analysis algorithm may be used for locating the lesions in the image by searching for areas of statistically high counts.

A lesion boundary 601a and 601b may be drawn (as shown at step 228 of FIG. 8) encompassing the lesion image. The center of the lesion may be determined by finding, for example the center of gravity of the lesion zone, by fitting a parabolic surface to the two-dimensional image, or finding a peak of the image after substantial smoothing. A profile 242 and 244 of the image count density along the axes 600a and 600b, respectively, extends through the center of the lesion. A background zone boundary 602a and 602b may be defined (as shown at step 230 of FIG. 8) outside the lesion zones 601a and 601b. The locations of the zones boundaries are shown on the profiles. It should be noted that the lesion boundary may not be circular. The shape of the lesion boundary depends on the image. Also, the lesion boundaries on the images may not be of the same size. The size of the lesion boundary depends on the image. In one embodiment, the lesion boundary sizes and shapes are similar. Additionally, the selection of the background boundary may include an entire zone 602 within the image of the breast 225a or 225b, may avoid statistically “hot” or “cold” areas, and/or may be comparable or larger than the area of the central lesion zone. At 228, the lesion is defined in the image data and, at 230, the background in defined in the image data. A background profile is then calculated using one of the methods of step 232.

In method 234 of FIG. 8, an average count of the background is determined from the total count in the annular background zone between boundaries 601 and 602, divided by the total area of the annular background zone. This average background is then subtracted at step 240 of FIG. 8 from the image. This method may cause some parts of the image to include negative values. Optionally, a maximum negative value within the lesion zone may be added to the image such that the lesion zone is non negative. Optionally, in the method 236, the background values in the annular background zone are fit to a plane with a slope. Values of the fit interpolated into the lesion zone are subtracted at step 240 from the values therein. Optionally, in method 238, a higher function fit, for example a cubic or quadratic function fit, is performed to define the background of each image. Values of the fit interpolated into the lesion zone are subtracted at step 240 from the values therein. At 240, the background is statistically subtracted from the image to provide a number of counts per lesion image. In some embodiments, method 230 is used first to remove the background. The image is then re-examined to re-define the zones and one of the methods 234, 236, and/or 238 is used on the newly defined zones.

Referring back to the method 200 of FIG. 4, the image data from detector 54 is compared to the image data from detector 56 using one of a plurality of methods 206, 208, 210, and 212 to determine a position of the lesion. Each of these methods will be described separately and in more detail below.

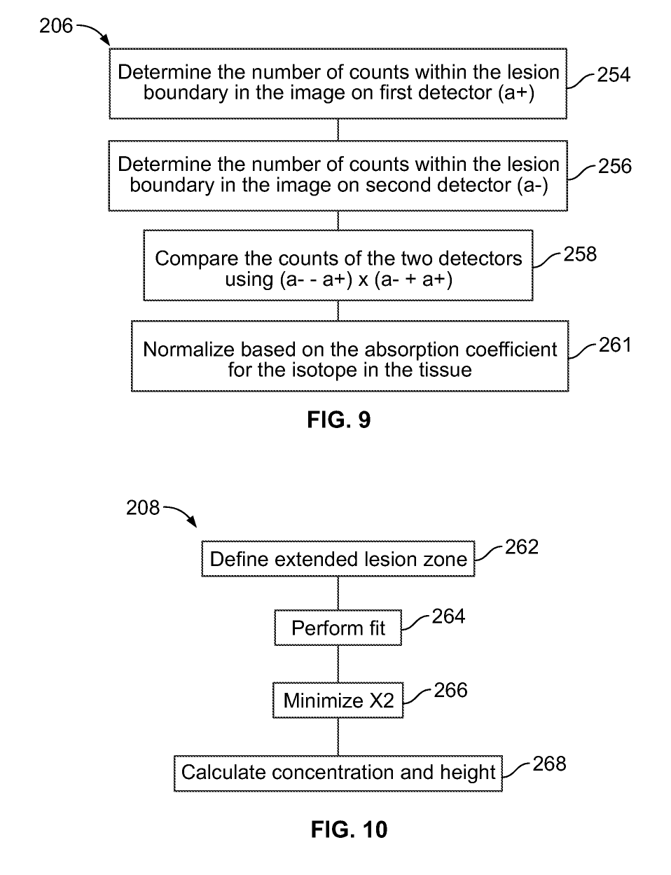

Referring to the count comparison method performed at 206 of FIG. 4, the method is described in more detail in FIG. 9. Specifically, at 254, the total number of counts a+detected by detector 54 within each the lesion image is determined from the image after the background is subtracted. Similarly, at 256, the number a of counts detected by detector 56 in the background is subtracted from the image of the lesion determined. The normalized ratio Es is defined at 258 using the following equation:

Es=(a⁻−a⁺)/(a⁻+a⁺)

wherein a⁺ is the number of counts in detector 54 approximately given by:

a⁺=Ae−^{μ(z+z)}

and a⁻ is the number of counts in the detector 56 given by:

a⁻=Ae−^{μ(z-z)}

where A is the number of counts that would have been counted in absence of attenuation; μ is the known attenuation coefficient of breast tissue for the photon energy used; Z is ½ the breast thickness (known from the distance between collimators); and z is the average distance of the lesion from the center plane between the two collimators. Accordingly, z is the location of the center of the lesion.

Under these assumptions, the location of the lesion (Z−z from the first collimator and Z+z from the second collimator) is given by finding z according to the equation:

z=Es/μ

For a thick breast, the location z may be estimated by solving for z in the following equation:

Es=μ_{z}[(1+(μ_{z}/6)²)/[(1+(μ_{z}/2)²)]

At 261 of FIG. 9, the estimated counts in the lesion may be adjusted for absorption by the equation:

A=(a⁺+a⁻)/(e^{-μz}+e^{-μz})

given the known Z and the calculated z.

Optionally, at 261, the images of the two detectors are combined into one two-dimensional image. With A and B as the two images, and C as the combined image, the combination operation may optionally be chosen from:
Arithmetic mean: C=A+B or C=(A+B)/2
Geometrical mean: C=Sqrt(A*B).
Fit: C=fit (A,B)
   Alternatively, A and B may be first separately deconvolved with the known collimator/detector response, based on the calculated lesion depth before combining A and B.

FIG. 10 illustrates the method 208 as shown in FIG. 4. At 208, the shape of the images can be analyzed to determine the actual size of the tumor and its depth. The analysis is performed using, for example, images 220 and 222. At 262, a region of interest (ROI) is placed over a feature assumed to be a lesion. The region of interest is defined within the image of the breast and does not expand outside of the image. The analysis may be performed on the “background subtracted” image after step 204, or on the raw data of step 202. The ROIs in this case have to extend beyond the lesion zone and include some background radiation zone, for example, zone 602a and 602b (shown in FIG. 7). If the background subtracted image is used, smaller ROIs such as 601a and 601b may be selected. A fit 264 of a uniform sphere lesion model is then used within the region of interest to obtain fit parameters. A function fitting is performed using the method of minimized least square error. Specifically, in the fitted counts function, the count is given by:

Cnt=Cnt_{bot}+Cntₜₒₚ, wherein

Crtₜₒₚ=B(1+ax+by)+2Cₜₒₚ[rₜₒₚ²−(x−x₀)²−(y−y₀)²]^{1/2}

Cnt_{bot}=B(1+ax+by)+2C_{bot}[r_{bot}²−(x−x₀)²−(y−y₀)²]^{1/2}, wherein:
Cntₜₒₚ and Cnt_{bot} are the intensity of the function (x,y) in the images for the two detectors.
   It should be noted that the background term “B(1+ax+by)” in the fitted counts function can be performed without using the terms ax and by (for a uniform background). In the case of using the background subtracted image, the background term “B(1+ax+by)” may be excluded. These terms are given to improve the accuracy of the count function. Higher order terms may also be used in addition.

In another embodiment, a chi square statistic is performed using:

χ2=Σ_{(x,y)}(image-function)2/(NDF), wherein NDF is a number of degrees of freedom determined by a number of pixels that have data and function=Cnt.

Accordingly, the output values of the fit parameter is determined as a result of the fitting process that minimizes χ2 at step 266. The fitting variables are:
Cₜₒₚ, C_{bot}, B, a, b, rₜₒₚ, r_{bot}, x₀, y₀, wherein:
B is background with slow linear variations a, b;
x₀, y₀ are best lesion position in x and y;
rₜₒₚ, r_{bot} are fitted apparent lesion size on the top and bottom; and
B, a, b, x₀, y₀ are common to the top and bottom;
   The inputs are:

Cₜₒₚ, C_{bot} are lesion activities as seen in the top and bottom detectors 54 and 56.

The collimator resolution function is given by:

r=rₜᵣᵤₑ+(1+scd)d/L, wherein

d is the size of the collimator bore, L is the height of or distance between the detectors, scd is the source to collimator distance, r is the detected lesion size, and rₜᵣᵤₑ is the true lesion size. The equation is applied to both the top detector 54 and the bottom detector 56 using the equations:

rₜₒₚ=rₜᵣᵤₑ+d+hd/L

r_{bot}=rₜᵣᵤₑ+d+(s−h)d/L

To find a true lesion diameter Ø these equations are added to eliminate h, giving the following equation:

Ø=rₜₒₚ+r_{bot}−d(2+s/L)

The lesion height is also determined by subtracting to eliminate rₜᵣᵤₑ using:

h=[(rtop−rbot)L/d+s]/2

The final lesion height is determined using a weighted average of each equation:

z0=(hₐwₐ+h_{b}w_{b})/(wₐ+w_{b}); wherein wₐ=1/Error(hₐ)

A tumor concentration is then determined at step 268 while preferably correcting for attenuation:

(Ctop+Cbot)˜2Ce−μz(1+(μz)2/2+ . . . )

After solving for C a tumor uptake ratio is determined using: C/B. Accordingly, the above equations provide the following outputs:
χ2=the probability that there is a lesion there in the 2 images;
x0, y0, z0=the 3D location of the tumor;
rtrue=the size of the tumor; and
C/B=the tumor background activity concentrations taking into account the volume of the spherical tumor and the volume of the background tissue.

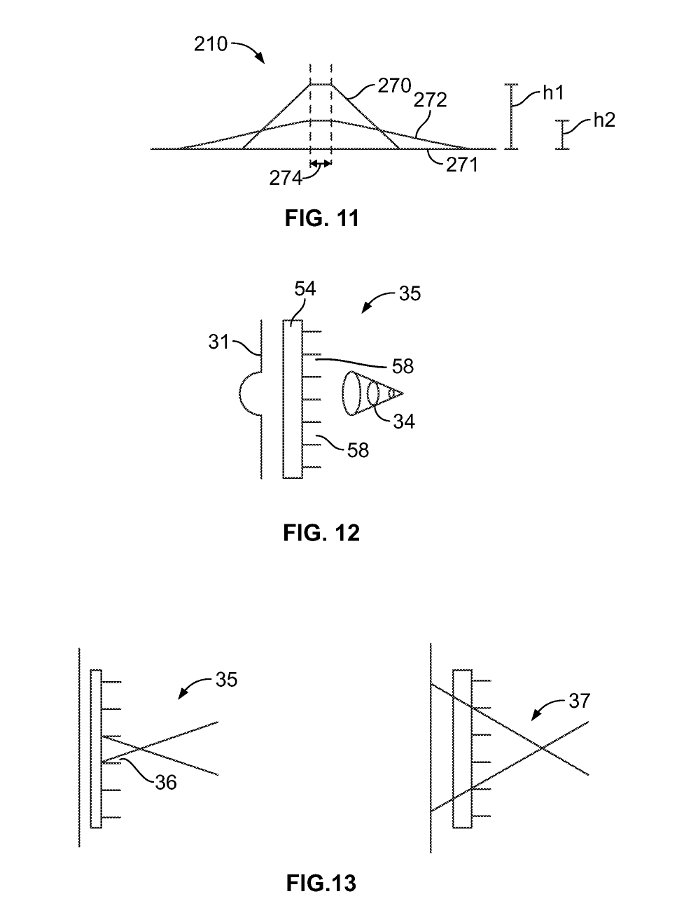

FIG. 11 schematically illustrates the lesion profile 210 of a collimator such as used in the camera. The graph 270 depicts the number of counts per second, detected by a specific pixel as a point source is moved along an axis 271 at a specific height h1 above the collimator's face. The pixel is aligned with a collimator bore and both have a width 274 along the axis 271.

The graph 272 depicts the number of counts per second, detected by the same pixel as the point source is moved along the axis 271 at a height h2, wherein h2 is larger than h1 above the collimator's face. With no attenuation, the integrals under the two graphs are similar or equal.

The actual lesion profiles are three dimensional and depict the responsivity of a pixel to appoint a source in a location {, x, y, h} relative to the pixel's center. This lesion profile may be modified by finite penetration through the collimator's septa. Generally, the function may be calculated from geometrical parameters of the collimator. This function may be used in the fit performed at step 264 and in methods 210 and 212.

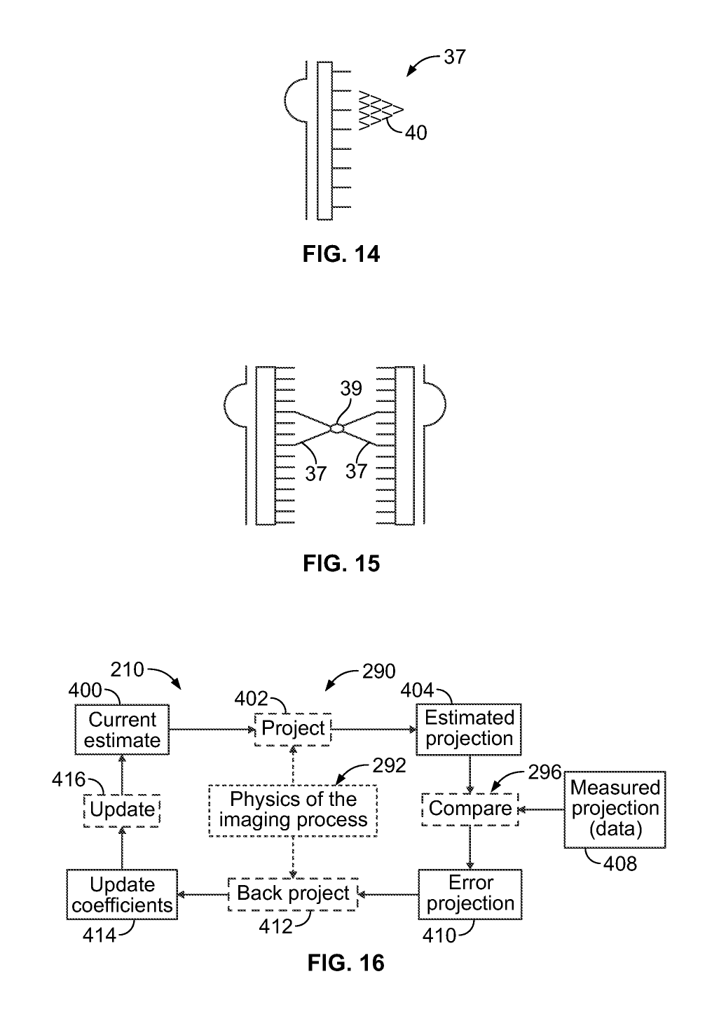

FIGS. 12-15 show the method 212 of FIG. 4, for finding a source location between two detector heads. The data input is shown in FIG. 12. The system transformation function and its inverse are shown in FIG. 13. And the source location computation is shown in FIG. 14.

FIG. 12 illustrates a planar detector 54 and a planar collimator 58 in cross section. The planar detector 54 and planar collimator 58 detect an image 31 from a tumor source (not shown). The image 31 has an intensity value for every point of the plane of the detector 54. The intensity is shown as a function of the cross section location. Without further information, such as absolute source activity or collimator sensitivity, the optics properties of the parallel hole collimators of the image are generated by a larger tumor source in front of and close to the collimator or a smaller source located further away, as shown by the lens shapes 34. The full locus of possible sources is illustrated by a cross section of a cone 35.

FIG. 13 shows an acceptance angle of a single collimator hole 36 as the area interior to the cross section of the cone 35 drawn between the walls the collimator hole 36. FIG. 13 illustrates an inverse or mirror of the acceptance cone as illustrated at 37. Outside of the inverted cone 37, tumor sources may illuminate more than the single hole.

FIG. 14 illustrates the locus corresponding to the full image built by repeated addition of single hole kernels 40. The kernels 40 are layered until the cone 37, in three-dimensions, is closed at its apex by a single kernel 40.

FIG. 15 illustrates the locus cone for each head constructed so that the intersection ellipse 39 of the cones 37 is calculated. The best estimate for the position and size of the tumor is then provided by the centroid and outline of the ellipse.

Referring to the iteration method performed at 210 of FIG. 4, this method is described in more detail in FIGS. 16-19. A typical iteration scheme is captured at 290. Specifically, at 292, a model of the tomographic system is built. It includes representation of the object to be reconstructed (breast having smooth background radiation, and lesion having higher concentration of radiation), representation of measured data and transfer function reflecting geometry and physics of the acquired lesion profile (for example as seen and discussed in FIG. 11), detector response function, energy resolution, depth of interaction, absorption, and the like. At 296, a relationship to be optimized is selected and expressed. Several examples include:

Maximum-likelihood expectation maximization:

$${x}^{( k + 1 )} = {arg min}_{x} ( - L ( g , x ) )$$

or Maximum a-posteriori:

$${x}^{( k + 1 )} = {arg min}_{x} ( - L ( g , x ) + β P ( x , {m}^{( k )} )$$

or Regularized least squares optimization:

$${min}_{f ∈ H} \frac{1}{2} {\sum }_{i = 1}^{n} {( f ( {X}_{i} ) - {Y}_{i} )}^{2} + \frac{λ}{2} {‖ f ‖}_{K}^{2}$$

Referring to FIG. 16, a current estimate 400 is forward projected at 402 using the tomographic model 292 to create an estimated projection 404. The estimated projection 404 is compared at 296 to a measured projection 408 to provide an error projection 410. The error projection 410 is backprojected at 412 using the tomographic model 292 to provide update coefficients 414. The update coefficients 414 are used to update at 416 the current estimate 400.

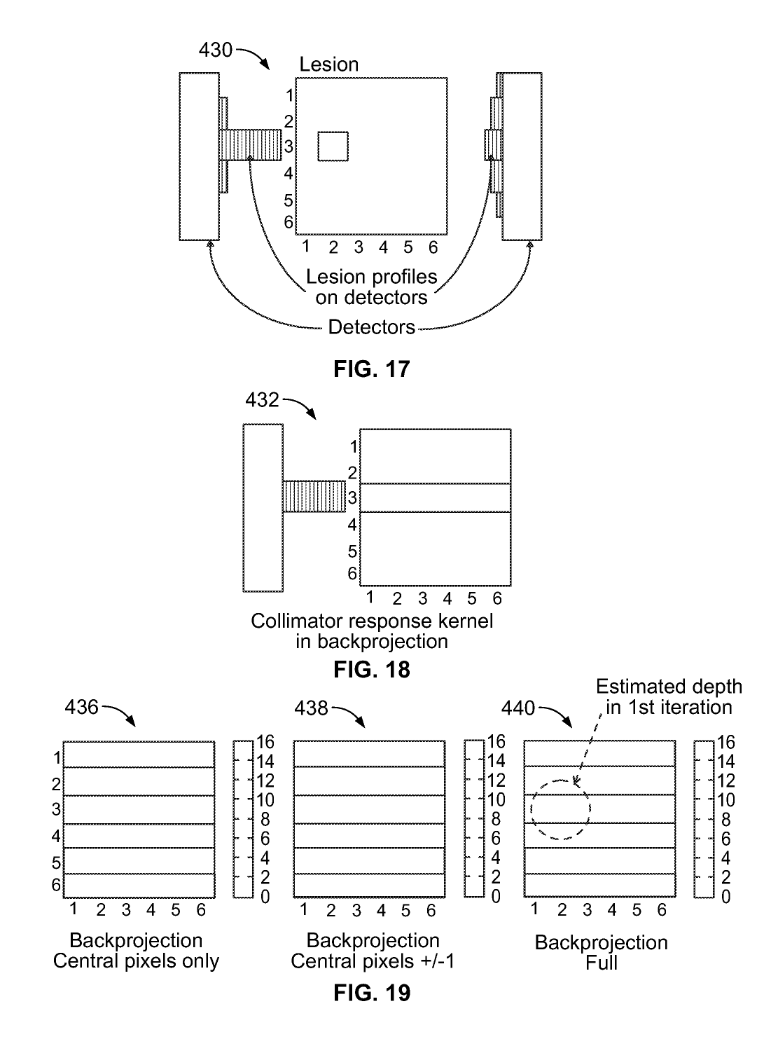

FIGS. 17-19 show schematics of the iterative method of 210 in a simple two-dimentional presentation. Given measured data (shown in FIG. 17 as lesion profiles 430), and collimator response kernel (representing system model) (shown in FIG. 18 at 432), one full backprojection operator (shown in FIG. 19) will results in an object estimate, as shown in FIG. 19, that already provides initial depth information. Noisy data with background activity will require a number (up to 10) of iterations in order to provide useful information. More robust and realistic implementation will perform full and accurate three-dimensional and/or four-dimensional modeling. Referring to FIG. 19, image 436 illustrates a backprojection having central pixels only. Image 438 illustrates a backprojection having central pixels+/−1. Image 440 illustrates a full backprojection.

Accordingly, referring to 216 of FIG. 4, a position of the lesion may be provided based on or using at least one of the methods 206, 208, 212, and 210. Due to differences in each of the methods, the estimated position of the lesion may vary from method to method. As such, at least some of the positions determined at 203 are weighted at 218 to determine a weighted position of the lesion using the following equation:

Weighted Position=Sum[Es(i)*W(i)]/Sum[W(i)]

wherein Es(i) is the estimated position of the lesion using one or more of the methods 206, 208, 212, and 210 and W(i) is the weight given to each estimated position. It should be noted that not all estimated positions are necessarily weighted. For example, outlying estimations can be eliminated if they are greater than a predetermined variance. Additionally, each method may be weighted differently based on the methods used or the data itself. W(i) may be fixed for each or some of the methods, or may vary depending on the estimated variability for the value Es(i), based on the specific data. For example, for a large lesion, the depth may be more accurately determined by method 206 than by other methods, and thus, a larger W(i) may be associated with method 206 when a large lesion is detected.

Accordingly, the various embodiments provide one or more methods for determining the existence, uptake, size and depth of a lesion in a breast. The methods can then be weighted to increase the accuracy of the determined location of the lesion. At least one technical effect of some embodiments includes enabling a depth of a lesion to be determined in women having, for example, dense breasts and/or implants and that are imaged using nuclear single photon imaging. By determining the depth of the lesion a biopsy needle may be more easily guided, thereby reducing the chance of missing the lesion with the needle. As a result, the number of samples taken may be reduced, thereby reducing pain and discomfort to the patient.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

As used herein, the term “computer readable medium” includes a tangible and non-transitory medium.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for determining a location of a lesion within a breast imaged between a first detector and a second detector, said method comprising:
acquiring a first image data set of the lesion with the first detector;
acquiring a second image data set of the lesion with the second detector, the first and second image data sets including nuclear single photon imaging information;
using the first image data set and the second image data set to calculate location information for the lesion; and
determining a location of the lesion within the breast based on the calculated location information.

2. A method in accordance with claim 1, wherein the determining operation further comprises weighting a plurality of location information to determine the location of the lesion within the breast.

3. A method in accordance with claim 1 wherein determining a location of the lesion further comprises determining the location of the lesion using pixel to pixel head registration.

4. A method in accordance with claim 1 further comprising analyzing the first image data set and the second image data set using a uniform sphere lesion model placed within a region of interest believed to contain a lesion.

5. A method in accordance with claim 1, wherein:
the calculated location information includes a number of events detected by the first detector and a number of events detected by the second detector; and
said determining operation further comprises comparing the number of events detected by the first detector to the number of events detected by the second detector.

6. A method in accordance with claim 1, wherein:
the calculated location information includes a lesion profile for a shape of the lesion detected by the first detector and a lesion profile for a shape of the lesion detected by the second detector; and
said determining operation further comprises comparing the lesion profile detected by the first detector to the lesion profile detected by the second detector.

7. A method in accordance with claim 1, wherein:
the calculated location information includes a number of events detected by the first detector and a lesion profile for a shape of the lesion detected by the first detector;
the calculated location information further includes a number of events detected by the second detector and a lesion profile for a shape of the lesion detected by the second detector; and
said determining operation further comprises comparing the number of events detected by the first detector to the number of events detected by the second detector, and comparing the lesion profile detected by the first detector to the lesion profile detected by the second detector.

8. A method in accordance with claim 1, wherein:
the calculated location information includes a linear iteration of the first image data set and a linear iteration of the second image data set; and
said determining operation further comprises comparing the linear iteration of the first image data set to the linear iteration of the second image data set.

9. A system for determining a location of a lesion within a breast, said system comprising:
a first detector and a second detector, the breast positioned between said first detector and said second detector, said first detector acquires a first image data set of the lesion and said second detector acquires a second image data set of the lesion; and
a location determining module that uses the first image data set and the second image data set to calculate location information for the lesion and determines a location of the lesion within the breast based on the calculated location information.

10. A system in accordance with claim 9, wherein said location determining module is positioned within said system.

11. A system in accordance with claim 9, wherein said location determining module is embodied on a computer readable medium that is readable by said system.

12. A system in accordance with claim 9, wherein said first detector and said second detector are two-dimensional detectors.

13. A system in accordance with claim 9, wherein said first detector is parallel to said second detector.

14. A method of determining a location of a lesion within a breast, said method comprising:
acquiring image data of a lesion using nuclear single photon imaging;
calculating a plurality of location information for the lesion using the acquired image data; and
weighting the plurality of location information to determine a location of the lesion within the breast.

15. A method in accordance with claim 14 further comprising subtracting a background from the image data.

16. A method in accordance with claim 14 further comprising analyzing the image data set using a uniform sphere lesion model placed within a region of interest believed to contain a lesion.

17. A method in accordance with claim 14, wherein said calculating operation further comprises calculating the location information based on a number of events acquired in the image data.

18. A method in accordance with claim 14, wherein said calculating operation further comprises calculating the location information based on a lesion profile of the image data.

19. A method in accordance with claim 14, wherein said calculating operation further comprises calculating the location information based on a number of events acquired in the image data and a lesion profile of the image data.

20. A method in accordance with claim 14, wherein said calculating operation further comprises calculating the location information based on a linear iteration of the image data.
